(19) United States
(12) Patent Application Publication
(10) Pub. No.: US 2020/0012030 A1
(43) Pub. Date: Jan. 9, 2020

(54) BACKLIGHT UNIT AND DISPLAY DEVICE INCLUDING THE SAME

(71) Applicant: Samsung Display Co., Ltd., Yongin-Si (KR)

(72) Inventors: Keun Woo PARK, Incheon (KR); Min Su KIM, Hwaseong-si (KR); Hong Beom LEE, Hwaseong-si (KR); Tae Woo LIM, Yongin-si (KR)

(21) Appl. No.: 16/213,387

(22) Filed: Dec. 7, 2018

(30) Foreign Application Priority Data
Jul. 5, 2018 (KR) 10-2018-0078118

(51) Int. Cl. F21V 8/00

(52) U.S. Cl. CPC G02B 6/005; G02B 6/0056

(57) ABSTRACT

Disclosed herein is a backlight unit, the backlight unit comprises a light guide plate; a wavelength conversion layer disposed above the light guide plate; and a reflective polarizing layer disposed above the wavelength conversion layer and comprising a patterned polarizer, wherein the wavelength conversion layer and the reflective polarizing layer are integrally formed as one piece.

This application claims priority to Korean Patent Application No. 10-2018-0078118 filed on Jul. 5, 2018 in the Korean Intellectual Property Office, the disclosure of which is incorporated herein by reference in its entirety.

### BACKGROUND

### 1. Field of the Disclosure

The present disclosure relates to a backlight unit and a display device including the same.

### 2. Description of the Related Art

A liquid-crystal display receives light from a backlight assembly and displays an image. Some backlight assemblies include a light source and a light guide plate. The light guide plate receives light from the light source and guides the light so that it travels toward the display panel. In some liquid-crystal display devices, a light source emits blue light, and it passes through a quantum dot (QD) layer to reproduce white light. Then, the white light is filtered with a color filter in the display panel to represent a color. White light represented by using quantum dots (QD) has excellent color gamut.

In order to change the randomly polarized light emitted from the backlight assembly into linearly polarized light, a polarizing plate is attached to the outside of the panel of the liquid-crystal display device. An absorptive polarizing plate is commonly employed. Unfortunately, such an absorptive polarizing plate is quite thick and absorbs the emitted light too much, thus decreasing the luminous efficiency.

### SUMMARY

Aspects of the present disclosure provide a backlight unit that is slimmer, has improved luminous efficiency and has good reliability.

Aspects of the present disclosure also provide a display device that is slimmer, has improved luminous efficiency and has good reliability.

These and other aspects, embodiments and advantages of the present disclosure will become immediately apparent to those of ordinary skill in the art upon review of the Detailed Description and Claims to follow.

According to an exemplary embodiment of the present disclosure, a backlight unit and a display device including the same can be made slimmer and can have improved luminous efficiency and excellent display quality compared with existing display devices.

It should be noted that effects of the present disclosure are not limited to those described above and other effects of the present disclosure will be apparent to those skilled in the art from the following descriptions.

According to an aspect of the present disclosure, there is provided a backlight unit, a backlight unit comprises a light guide plate; a wavelength conversion layer disposed above the light guide plate; and a reflective polarizing layer disposed above the wavelength conversion layer and comprising a patterned polarizer, wherein the wavelength conversion layer and the reflective polarizing layer are integrally formed as one piece.

In an exemplary embodiment, a backlight unit may include a low-refractive layer disposed between the light guide plate and the wavelength conversion layer; and a passivation layer disposed between the wavelength conversion layer and the reflective polarizing layer. The light guide plate, the wavelength conversion layer and the reflective polarizing layer may be integrally formed as one piece.

In an exemplary embodiment, the passivation layer may comprise a first passivation layer disposed on the wavelength conversion layer, a second passivation layer disposed on the first passivation layer, and a third passivation layer disposed on the second passivation layer.

In an exemplary embodiment, the first passivation layer and the third passivation layer may comprise an inorganic material, and wherein the second passivation layer comprises an organic material.

In an exemplary embodiment, a backlight unit may comprise a top cover layer disposed on the reflective polarizing layer.

In an exemplary embodiment, the top cover layer may comprise an inorganic material, and wherein a thickness of the top cover layer is larger than a thickness of the first passivation layer and a thickness of the third passivation layer.

In an exemplary embodiment, the thickness of the top cover layer may be 0.5 μm to 0.9 μm.

In an exemplary embodiment, the top cover layer may comprise a first top cover layer comprising an inorganic material and a second top cover layer disposed on the first top cover layer and comprising an inorganic material different from that of the first top cover layer.

In an exemplary embodiment, the thickness of the top cover layer may be larger than the thickness of the first passivation layer and the thickness of the third passivation layer.

In an exemplary embodiment, a density of the top cover layer may be larger than a density of the first passivation layer and a density of the third passivation layer.

In an exemplary embodiment, the top cover layer may comprise a first top cover layer and a second top cover layer disposed on the first cover layer, and wherein the first top cover layer comprises an inorganic material and the second top cover layer comprises an organic material.

In an exemplary embodiment, a backlight unit may further comprise a third top cover layer between the first top cover layer and the second top cover layer, wherein a density of the third top cover layer is greater than a density of the first top cover layer.

According to an aspect of the present disclosure, there is provided a display device, a display device comprises a backlight assembly comprising a light guide plate, a wavelength conversion layer disposed above the light guide plate, a reflective polarizing layer disposed above the wavelength conversion layer and comprising a patterned polarizer, and a light source disposed on one side of the light guide plate; and a liquid-crystal display panel disposed above the backlight assembly, wherein the wavelength conversion layer and the reflective polarizing layer are integrally formed as one piece.

In an exemplary embodiment, a display device may further comprise a low-refractive layer disposed between the light guide plate and the wavelength conversion layer; and a passivation layer disposed between the wavelength conversion layer and the reflective polarizing layer. The light guide plate, the wavelength conversion layer and the reflective polarizing layer may be integrally formed as one piece.

In an exemplary embodiment, the passivation layer may comprise a first passivation layer disposed on the wavelength conversion layer, a second passivation layer disposed on the first passivation layer, and a third passivation layer disposed on the second passivation layer.

In an exemplary embodiment, the first passivation layer and the third passivation layer may comprise an inorganic material, and the second passivation layer comprises an organic material.

In an exemplary embodiment, a display device may further comprise a top cover layer disposed on the reflective polarizing layer.

In an exemplary embodiment, the top cover layer may comprise an inorganic material, and wherein a thickness of the top cover layer is larger than a thickness of the first passivation layer and a thickness of the third passivation layer.

In an exemplary embodiment, the top cover layer may comprise a first top cover layer, a second top cover layer disposed on the first cover layer, wherein the first top cover layer comprises an inorganic material, and the second cover layer comprises an organic material.

In an exemplary embodiment, a display device may further comprise a third top cover layer between the first top cover layer and the second top cover layer, wherein a density of the third top cover layer is greater than a density of the first top cover layer.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is an exploded, perspective view of a backlight unit according to an exemplary embodiment of the present disclosure;

FIG. 2 is a cross-sectional view of the backlight unit disclosed in FIG. 1;

FIGS. 3 and 4 are cross-sectional views of low-refractive layers according to various exemplary embodiment of the present disclosure;

FIG. 5 is a perspective view of a polarizing member according to an exemplary embodiment of the present disclosure;

FIG. 6 is a cross-sectional view of a polarizing member according to an exemplary embodiment of the present disclosure;

FIG. 7 is a cross-sectional view of a backlight unit according to another exemplary embodiment of the present disclosure;

FIGS. 8, 9, 10, 11 and 12 are cross-sectional views of a polarizing member according to other exemplary embodiments of the present disclosure;

FIG. 13 is an exploded, perspective view of a display device according to various exemplary embodiments of the present disclosure;

FIG. 14 is a cross-sectional view of a display device according to various exemplary embodiments of the present disclosure; and

FIG. 15 is a cross-sectional view of a display device according to various exemplary embodiments of the present disclosure.

### DETAILED DESCRIPTION OF THE EMBODIMENTS

The advantages and features of the inventive concept and methods for achieving the advantages and features will be apparent by referring to the embodiments to be described in detail with reference to the accompanying drawings. However, the inventive concept is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the inventive concept, and the inventive concept is only defined within the scope of the appended claims.

Where an element is described as being related to another element such as being “on” another element or “located on” a different layer or a layer, includes both a case where an element is located directly on another element or a layer and a case where an element is located on another element via another layer or still another element. In contrast, where an element is described as being is related to another element such as being “directly on” another element or “located directly on” a different layer or a layer, indicates a case where an element is located on another element or a layer with no intervening element or layer therebetween.

Hereinafter, exemplary embodiments of the present disclosure will be described in detail with reference to the accompanying drawings.

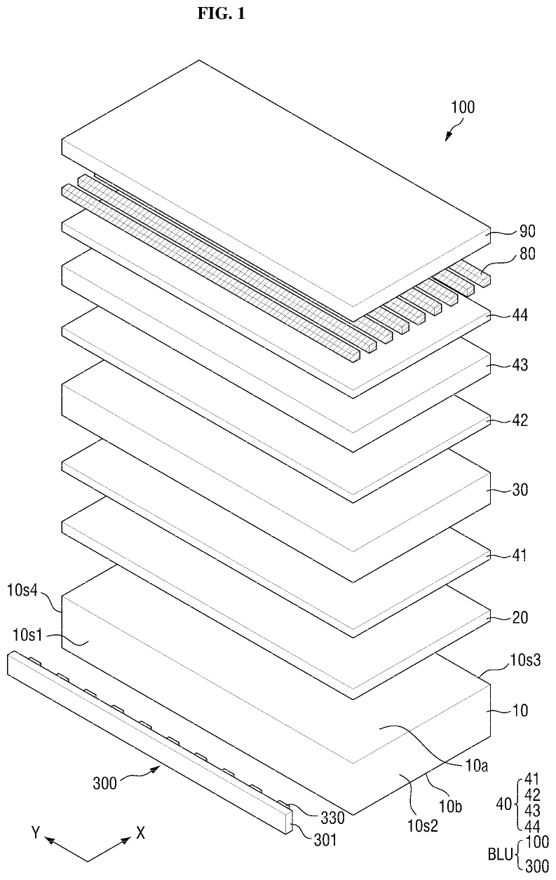

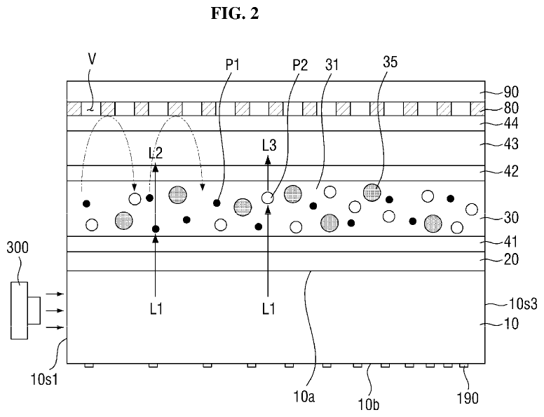

FIG. 1 is an exploded, perspective view of a backlight unit according to an exemplary embodiment of the present disclosure. FIG. 2 is a cross-sectional view of the backlight unit disclosed in FIG. 1.

Referring to FIGS. 1 and 2, a backlight unit BLU includes a light source 300 and an optical member 100. The light source 300 may be disposed on one side of the optical member 100. The optical member 100 may receive the light emitted from the light source and may convert or control the path and/or wavelength of the light.

The light source 300 may include a printed circuit board 301 and a plurality of LEDs 330 mounted on the printed circuit board 301. The light source 300 may be disposed adjacent to at least one side of a light guide plate 10. Specifically, the printed circuit board 301 may be disposed adjacent to at least one side face of the light guide plate 10. The plurality of LEDs 330 may be disposed on the printed circuit board 301 such that they are spaced apart from one another. Although the LEDs 330 are disposed on the side face 10S1 located on the longer side of the light guide plate 10 in the example shown in FIG. 1, this is merely illustrative. For example, the LEDs 330 may be disposed adjacent to both side faces 10S1 and 10S3 of the longer sides or may be disposed adjacent to one or both of the side faces 10S2 and 10S4 of the shorter sides. In the following description, the light source 300 is disposed on the side face 10S1 located on the longer side of the light guide plate 10. In this example, the light source 300 may be disposed along the y-direction (the second direction). In the exemplary embodiment shown in FIG. 1, the side face 10S1 of the longer side of the light guide plate 10 to which the light source 330 is disposed adjacent serves as the light incidence surface on which light is directly incident (denoted by 10S1 in the drawings). The side face 10S3 of the other longer side opposed to it serves as the opposite surface (denoted by 10S3 in the drawings). The light incidence surface of the light guide plate 10 may extend parallel with the light source 300 in the y-direction (second direction). The opposite surface of the light guide plate 10 may be spaced apart from the light incidence surface and may also extend in parallel with the light source 300 in the y-direction (second direction).

In an exemplary embodiment, the LEDs 330 may be top-emitting LEDs that emit light upward, as shown in FIG. 1. It is, however, to be understood that the present disclosure is not limited thereto. The LEDs 330 may be side-emitting LEDs that emit light laterally. The LEDs 330 may be blue LEDs that emit the first wavelength light L1 of the first wavelength band (e.g., blue wavelength band). The first wavelength band may range from 420 nm to 470 nm. It is, however, to be understood that the present disclosure is not limited thereto. The LEDs 330 may emit light in the near-ultraviolet (NUV) wavelength band close to the blue wavelength band.

The optical member 100 may include a light guide plate 10, a wavelength conversion layer 30 on the light guide plate 10, and a patterned polarizer 80 disposed on the wavelength conversion layer 30. The optical member 100 may further include a low-refractive layer 20 disposed between the light guide plate 10 and the wavelength conversion layer 30. The optical member 100 may include a plurality of passivation layers each disposed on the upper surfaces of the respective elements 20 and 30 of the optical member 100 to thereby protect the elements 20 and 30 from the outside. The elements of the optical member 100 may be combined together as a single element.

The light guide plate 10 serves to guide the path of light.

The light guide plate 10 may generally have a polygonal shape. The shape of the light guide plate 10 may be, but is not limited to being, a rectangle when viewed from the top. In an exemplary embodiment, the light guide plate 10 may be a hexahedron having a rectangle shape when viewed from the top and may include an upper face 10a, a lower face 10b and four side faces 10S; 10S1, 10S2, 10S3 and 10S4.

In an exemplary embodiment, each of the upper face 10a and the lower face 10b of the light guide plate 10 is positioned on a plane, and the plane on which the upper face 10a is located generally parallel to the plane on which the lower face 10b is located, so that the light guide plate 10 may have a uniform thickness.

A scattering pattern 190 may be disposed on the lower face 10b of the light guide plate 10. The scattering pattern 11 changes the angle of the light traveling in the light guide plate 10 by total reflection so that the light exits out of the light guide plate 10.

In an exemplary embodiment, the scattering pattern 11 may be implemented as a separate layer or a pattern. For example, a pattern layer including protrusions or depressions may be formed on the lower face 10b of the light guide plate 10 or a printed pattern may be formed thereon to function as the scattering pattern 11. Although the scattering pattern 11 includes rectangular protrusions in the drawings, this is merely illustrative. The scattering pattern 11 may be formed with a combination of various shapes such as semicircle, semi-ellipse and triangle.

The density of the scattering pattern 11 may vary depending on the regions. For example, the scattering pattern may have a lower density adjacent to the light incidence surface 10s1 where a larger amount of light travels, and may have a higher density adjacent to the opposite surface 10s3 where a smaller amount of light travels.

The light guide plate 10 may include an inorganic material or an organic material. For example, the light guide plate 10 may be made of, but is not limited to, glass.

The low-refractive layer 20 may be disposed on the upper face 10b of the light guide plate. The low-refractive layer 20 is formed directly on the upper face 10b of the light guide plate and may come in contact with the upper face 10b of the light guide plate. The low-refractive layer 20 is interposed between the light guide plate 10 and the wavelength conversion layer 30 to facilitate the total reflection of the light guide plate 10.

The low-refractive layer 20 may include an organic resin having a low refractive index. The low-refractive layer 20 may be formed directly on the light guide plate 10 by coating an organic resin layer. The difference between the refractive index of the passivation layer 41 and the refractive index of the low-refractive layer 20 may be equal to or greater than 0.2. When the refractive index of the low-refractive layer 20 is smaller than the refractive index of the light guide plate 10 by 0.2 or more, a sufficient total reflection can be achieved by the upper surface of the light guide plate 10. The difference between the refractive index of the light guide plate 10 and the refractive index of the low-refractive layer 20 has no upper limit. However, the upper limit may be typically one or less when considering the refractive indices of the material of the light guide plate 10 and the low-refractive layer 20.

The refractive index of the low-refractive layer 20 may range from 1.2 to 1.4. If the refractive index of the low-refractive layer 20 is 1.2 or more, it is possible to prevent the fabricating cost from increasing too much. If the refractive index of the low-refractive layer 20 is 1.4 or less it is advantageous to make the total reflection critical angle of the upper face 10a of the light guide plate 10 sufficiently small. In an exemplary embodiment, the low-refractive layer 20 having a refractive index of approximately 1.25 may be employed.

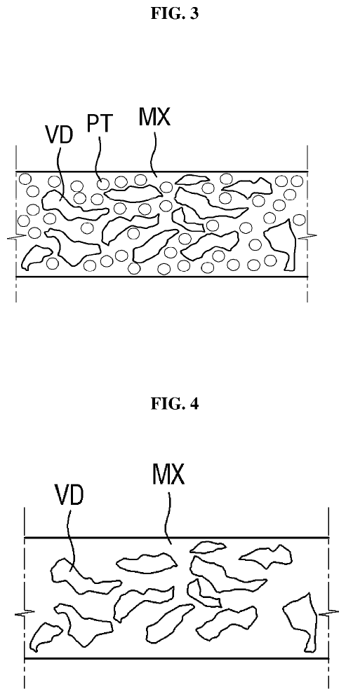

The low-refractive layer 20 may include voids to achieve the above-mentioned low refractive index. The voids may be made in vacuum or may be filled with an air layer, gas, or the like. The space of the voids may be defined by particles, matrix, and so on. The voids will be described in detail with reference to FIGS. 3 and 4.

FIGS. 3 and 4 are cross-sectional views of low-refractive layers according to various exemplary embodiment of the present disclosure.

Referring to FIGS. 3 and 4, in an exemplary embodiment, the low-refractive layer 20 may include a plurality of particles PT, a matrix MX which surrounds the particles PT as a single piece, and voids VD. The particles PT may work as filler that adjusts the refractive index and the mechanical strength of the low-refractive layer 20.

The particles PT may be dispersed inside the matrix MX in the low-refractive layer 20, and the matrix MX may be partially opened so that the voids VD may be formed in the opened portions. For example, the particles PT and the matrix MX may be mixed in a solvent, and then may be dried and/or cured so that the solvent evaporates. In doing so, the voids VD may be formed between the opened portions of the matrix MX.

In another exemplary embodiment, the low-refractive layer 20 may include a matrix MX and voids VD without particles PT, as shown in FIG. 4. For example, the low-refractive layer 20 may include a matrix MX as a single continuous piece, such as a foaming resin, and voids VD formed therein.

Referring back to FIGS. 1 and 2, a first passivation layer 41 may be disposed on the low-refractive layer 20. The first passivation layer 41 serves to prevent permeation of moisture and/or oxygen (hereinafter referred to as “moisture/oxygen”) into the low-refractive layer 20.

Although the side faces of the first passivation layer 41 are aligned with (or in line with or overlap with) the side faces of the low-refractive layer, respectively, in the example shown in the drawings, the first passivation layer 41 may cover the side faces of the low-refractive layer 20 in other implementations.

The first passivation layer 41 may contain an inorganic material. For example, the first passivation layer 41 may include silicon nitride, aluminum nitride, zirconium nitride, titanium nitride, hafnium nitride, tantalum nitride, silicon oxide, aluminum oxide, titanium oxide, tin oxide, cerium oxide and silicon oxynitride, or a metal thin film with light transmittance. The first passivation layer 41 may be formed directly on the low-refractive layer 20 by depositing an inorganic material.

The first passivation layer 41 made of an inorganic material may be an inorganic capping layer or a low-refractive capping layer that caps the low-refractive index layer 20 thereunder.

The thickness of the first passivation layer 41 may range from 0.4 to 0.7 μm.

The wavelength conversion layer 30 is disposed on the first passivation layer 41. The wavelength conversion layer 30 serves to convert the wavelength of at least a part of the light incident on the wavelength conversion layer 30. The wavelength conversion layer may include a binder layer 31, wavelength converting particles P1 and P2, and scattering particles 35.

The wavelength conversion layer 30 may cover the upper surface of the first passivation layer 41 and may completely overlap the low-refractive layer 20 and the first passivation layer 41.

In the drawings, the inclination angle of the side faces of the wavelength conversion layer 30 is substantially right angle, and the side faces of the wavelength conversion layer 30 are aligned with (or in line with or overlap with) the side faces of the first passivation layer 41 and the low-refractive layer 20. It is, however, to be understood that the present disclosure is not limited thereto. The inclination angle of the side faces of the wavelength conversion layer 30 may be smaller than the inclination angle of the side faces of the low-refractive layer 20. For example, when the wavelength conversion layer 30 is formed by slit coating or the like, which will be described later, the side faces of the relatively thick wavelength conversion layer 30 may have a gentler inclination angle than that of the side faces of the low-refractive layer 20.

The wavelength conversion layer 30 may be formed by coating and the like. For example, a wavelength conversion composition may be slit-coated on the light guide plate 10 where the low-refractive layer 20 and the first passivation layer 41 are formed, and then it is dried and cured, so that the wavelength conversion layer 30 may be formed. It is, however, to be understood that the present disclosure is not limited thereto. A variety of other stacking methods may be employed.

The wavelength conversion layer 30 may be thicker than the low-refractive layer 20. The thickness of the wavelength conversion layer 30 may range approximately from 5 to 30 μm. In an exemplary embodiment, the thickness of the wavelength conversion layer 30 may be approximately 8 μm.

The wavelength conversion layer 30 converts the wavelength of at least a part of incident light. The wavelength conversion layer 30 may include a binder layer 31 and wavelength converting particles P1 and P2 dispersed in the binder layer 31. The wavelength conversion layer 30 may further include scattering particles 35 dispersed in the binder layer 31.

The wavelength converting particles may include first wavelength converting particles P1 and second wavelength converting particles P2. The first wavelength converting particles P1 absorb light having a specific wavelength (e.g., a wavelength shorter than the second wavelength λ1) and converts it into the second wavelength light L2 having the second wavelength λ2. The second wavelength converting particles P2 absorb light having a specific wavelength (e.g., a wavelength shorter than the third wavelength λ3) and convert it into the light L3 having the third wavelength λ3. As will be described later, the wavelength converting particles P1 and P2 may absorb different wavelength bands depending on their constituent materials and/or diameters. In an exemplary embodiment, the wavelength of the second wavelength light L2 may fall within a wavelength band of approximately 520 nm to 570 nm (typically green light). The wavelength of the third wavelength band L3 may range from approximately 620 nm to 670 nm (typically red light). It is, however, to be understood that the wavelengths of red, green and blue are not limited to the above numerical values and may encompass all wavelength ranges that can be recognized as red, green and blue in the art.

The wavelength conversion layer 30 may further include wavelength converting particles for performing other wavelength conversion in addition to the first wavelength converting particles P1 and the second wavelength converting particles P2. For example, when the near-ultraviolet (NUV) wavelength LEDs are used for the light source 300, the wavelength conversion layer 30 may further include third wavelength converting particles P3 that converts the light of the near ultraviolet wavelength band into the light of the first wavelength λ1 (blue wavelength band).

The binder layer 31 is a medium in which the wavelength converting particles P1 and P2 are dispersed. The binder layer 31 may be composed of various resin compositions, which may be typically referred to as binders.

The wavelength converting particles P1 and P2 may be made of quantum dots (QD) or a fluorescent material.

According to an exemplary embodiment of the present disclosure, a quantum dot (QD), which is one type of the first wavelength converting particles P1 and the second wavelength converting particles P2, is a material with a crystal structure of several nanometers in size, and consist of hundreds to thousands of atoms. It exhibits the quantum confinement effect which leads to an increase in the energy band gap due to the small size. When a light of a wavelength having an energy level higher than the bandgap is incident on a quantum dot (QD), the quantum dot is excited by absorbing the light and relaxed to the ground state while emitting light of a particular wavelength. The emitted light of the wavelength has a value corresponding to the band gap. By adjusting the size and composition of the quantum dots (QD), the luminescence characteristics due to the quantum confinement effect can be adjusted.

A quantum dot (QD) may include, for example, at least one of a group II-VI compound, a group II-V compound, a group III-VI compound, a group III-V compound, a group IV-VI compound, a group I-III-VI compound, a group II-IV-VI compound, and a group II-IV-V compound.

A quantum dot (QD) may include a core and a shell overcoating the core. The core may be, but not limited to, at least one of CdS, CdSe, CdTe, ZnS, ZnSe, ZnTe, GaN, GaP, GaAs, GaSb, AlN, AlP, AlAs, AlSb, InP, InAs, InSb, SiC, Ca, Se, In, P, Fe, Pt, Ni, Co, Al, Ag, Au, Cu, FePt, Fe2O3, Fe3O4, Si and Ge. The shell may include, but not limited to, at least one of ZnS, ZnSe, ZnTe, CdS, CdSe, CdTe, HgS, HgSe, HgTe, AlN, AlP, AlAs, AlSb, GaN, GaP, GaAs, GaSb, GaSe, InN, InP, InAs, InSb, TlN, TlP, TlAs, TlSb, PbS, PbSe and PbTe.

In an exemplary embodiment, the first wavelength converting particles P1 may be smaller than the second wavelength converting particles P2. This is due to the quantum confinement effect that the energy band gap becomes larger as the size is smaller. Therefore, the wavelength of the light emitted by the first wavelength converting particles P1 may be shorter than the wavelength of the light emitted by the second wavelength converting particles P2.

A part of the first wavelength light L1 incident on the wavelength conversion layer 30 from the light guide plate 10 may be absorbed by the first wavelength converting particles P1 and converted into the second wavelength light L2 and emitted. Another part thereof may be absorbed by the second wavelength converting particles P2 and converted into the third wavelength light L3 and emitted. The other part thereof may collide with none of the first wavelength converting particles P1 and the second wavelength converting particles P2 and may be emitted. Accordingly, the light having passed through the wavelength conversion layer 30 may include all of the first wavelength light L1, the second wavelength light L2 and the third wavelength light L3. When the first wavelength light L1 is blue light, the second wavelength light L2 is green light and the third wavelength light L3 is red light as described above, the light passed through the wavelength conversion layer 30, which is a mixture thereof, may be white light. It is to be noted that the white light exiting from the wavelength conversion layer 30 may exhibit a sharp spectrum having a narrow half width in each of the blue, green, and red wavelength bands. Therefore, excellent color gamut can be achieved generally.

The wavelength conversion layer 30 may further include scattering particles 35. The scattering particles 35 may be non-quantum dots, which do not perform wavelength conversion. The scattering particles 35 scatter the incident light so that more incident light can be incident on the wavelength converting particles P1 and P2. In addition, the scattering particles 35 may regulate the exit angles of lights having different wavelengths. The scattering particles 35 may be made of one of metal oxides including SiO₂, TiO₂, ZnO and SnO₂ or a combination of two or more thereof.

The content of the scattering particles 35 in the wavelength conversion layer 30 may be 5% or less, or 2% or less.

A second passivation layer 42 is disposed on the wavelength conversion layer.

The second passivation layer 42 serves to prevent permeation of moisture and/or oxygen (hereinafter referred to as “moisture/oxygen”) into the wavelength conversion layer 30.

Although the side faces of the second passivation layer 42 are aligned with (or in line with or overlap with) the side faces of the wavelength conversion layer, respectively, in the example shown in the drawings, the second passivation layer 42 may cover even the side faces of the wavelength conversion layer 30 and the upper surface of the first passivation layer 41.

The second passivation layer 42 may contain an inorganic material. The second passivation layer 42 may be made of the same material as the first passivation layer 41. In addition, the thickness of the second passivation layer 42 may be substantially equal to the thickness of the first passivation layer 41. The second passivation layer 42 may be formed directly on the first passivation layer 41 by depositing an inorganic material.

A third passivation layer 43 may be disposed on the second passivation layer 42.

The third passivation layer 43 may be disposed to provide a flat surface, to increase light transmittance and/or to mitigate impact. The third passivation layer 43 can effectively block a liquid such as a process liquid to prevent an external process liquid and the like from permeating into the wavelength conversion layer 30. Further, the third passivation layer 43 is made of an organic material which has a density lower than that of the inorganic material. Accordingly, the third passivation layer 43 can mitigate external impact to thereby protect the inside from the external impact exerted when the device is pressed or foreign matter is introduced.

The third passivation layer 43 may include an epoxy resin, an acrylic resin, a cardo resin, an imide resin, a siloxane resin, or a silsesquioxane resin, or the like. The third passivation layer 43 may be formed directly on the second passivation layer 42 by coating an organic material.

The thickness of the third passivation layer 43 may range from 2 to 4 μm.

A fourth passivation layer 44 is disposed on the third passivation layer 43. The fourth passivation layer 44 may include the same material as the first and second passivation layers 41 and 42. The fourth passivation layer 44 may serve as a base for supporting the patterned polarizer 80 from below. The thickness of the fourth passivation layer 44 may be substantially equal to the thickness of the first passivation layer 41. The fourth passivation layer 44 may be formed directly on the third passivation layer 43 by depositing an inorganic material.

The fourth passivation layer 44 may protect the underlying features such as the third passivation layer 43 during the process of fabricating the patterned polarizer 80. Specifically, when a dry etching process is carried out to form the patterned polarizer 80, the fourth passivation layer 44 serves as an etch stopper to prevent the third passivation layer 43 thereunder from being inadvertently etched. In addition, it is possible to prevent the patterned polarizer 80 from being damaged or corroded by permeation of air or moisture from the bottom, thereby improving the reliability of the display device.

A reflective polarizing layer may be disposed on the fourth passivation layer 44. The reflective polarizing layer may reflect the polarization components that oscillate in the direction parallel to the reflection axis. For example, the reflective polarizing layer may transmit a p-wave while reflecting a s-wave, such that polarized light can be provided to the liquid-crystal display panel with improved luminous efficiency and improved luminance.

The reflective polarizing layer may include the patterned polarizer 80 of parallel straight lines. The patterned polarizer 80 may include a wire grid pattern layer.

The reflective polarizing layer, along with the liquid-crystal layer (not shown) and the polarizing plate to be described, may perform a light shutter function to thereby to control the amount of light exiting through the display surface. As used herein, “reflective polarizing characteristics” refers to the characteristics that allow polarization components oscillating in parallel to the transmission axis to transmit whereas polarization components oscillating perpendicular to the transmission axis to partially reflect, so that the transmitted light is polarized.

The parallel straight lines of the patterned polarizer 80 may extend in one direction. The lines may be arranged at regular intervals. In an exemplary embodiment, the lines may be arranged substantially in parallel to the direction in which the light source 300 extends, and to the direction in which the light incidence surface 10S1 and the opposite surface 10S3 of the light guide plate 10 extends. For example, the lines of the patterned polarizer 80 may extend in the y-direction (i.e., the second direction) and may be arranged in parallel to the light source 300, the light incidence surface 10S1 and the opposite surface 10S3.

The lines of the patterned polarizer 80 may be spaced apart from one another in the x-direction (i.e., the first direction). The lines of the patterned polarizer 80 may have a width W₈₀ and the spacing distance L₈₀ in the first direction X. The sum of the width W₈₀ and the spacing distance L₈₀ of one of the lines may be defined as the pitch P80 of the patterned polarizer 80. In addition, the patterned polarizer 80 has the thickness t₈₀ in the third direction Z.

The polarization and transmission characteristics of the patterned polarizer 80 are affected by the width W₈₀, the thickness t₈₀ and the pitch P80 thereof. Specifically, in order to perform the polarizing function of the patterned polarizer 80, it is preferable that the pitch P80 of the polarizing pattern 80 is smaller than the wavelength of the incident light. According to an exemplary embodiment of the present disclosure, it is desired that the pitch P80 of the patterned polarizer 80 is 200 nm or less, taking into account the wavelength bands of the incident light, i.e., the first wavelength light L₁, the second wavelength light L₂ and the third wavelength light L₃ (approximately 400 nm to 700 nm). For example, the width W₈₀ of the patterned polarizer 80 in the second direction Y may be approximately 20 to 80 nm. In addition, the spacing distance L₈₀ between the adjacent lines of the patterned polarizer 80 may be approximately 20 nm to 80 nm.

In addition, the thickness t₈₀ of the lines of the patterned polarizer 80 in the third direction Z may be approximately 70 nm to 1,200 nm. The patterned polarizer 80 can exhibit sufficient reflective polarization characteristics when the thickness of the lines ranges from 70 nm to 1,200 nm. Such thickness is much smaller than the thickness of the typical polarizing films of 5 μm to 100 μm, which are attached to a liquid-crystal panel. By disposing the patterned polarizer 80 in the backlight unit BLU as in this exemplary embodiment, one polarizing film attached to the liquid-crystal panel can be eliminated, thereby reducing the overall thickness of the display device.

In some other exemplary embodiments, the lines of the patterned polarizer 80 may extend in the x-direction (e.g., the first direction) and spaced apart from one another in the y-direction (e.g., the second direction). In this example, the lines of the patterned polarizer 80 are arranged substantially perpendicular to the light source 300, the light incidence surface 10S1, and the opposite surface 10S3.

In some other exemplary embodiments, the patterned polarizer 80 may extend in an oblique direction with respect to the light source 300, the light incidence surface 10S1, and the opposite surface 10S3. The oblique direction of the patterned polarizer 80 may be a direction between the x-direction and the y-direction. In this case, the lines of the patterned polarizer 80 may also be spaced apart from one another in the oblique direction with respect to the light source 300, the light incidence surface 10S1 and the opposite surface 10S3.

The lines may extend in different directions based on the relationship with the transmission axis of the upper polarizing film of the liquid-crystal display panel.

The patterned polarizer 80 may be made of a material having excellent light reflectivity. For example, the patterned polarizer 80 may include a metallic material. Specifically, the patterned polarizer 80 may include aluminum (Al), silver (Ag), gold (Au), copper (Cu), titanium (Ti), molybdenum (Mo), nickel (Ni), an oxide thereof, or an alloy thereof. The patterned polarizer 80 may be formed directly on the fourth passivation layer 44. For example, a metal layer is directly formed on the fourth passivation layer 44 and the metal layer is patterned using a conventional photolithography to form a patterned polarizer 80.

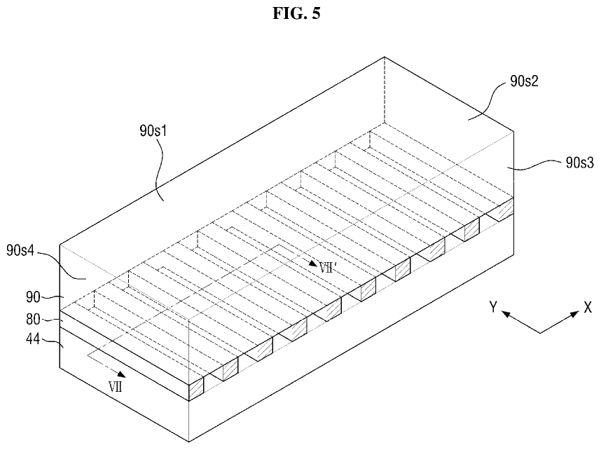

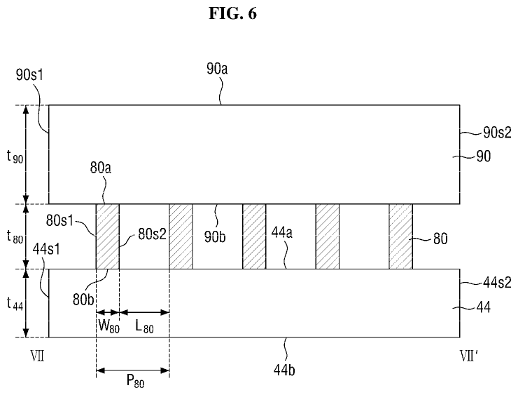

A top cover layer 90 for protecting the patterned polarizer 80 from the outside may be disposed on the patterned polarizer 80. The top cover layer 90 will be described in detail below with reference to FIGS. 5 and 6.

FIG. 5 is a perspective view of a patterned polarizer and a top cover layer according to an exemplary embodiment of the present disclosure. FIG. 6 is a cross-sectional view of the patterned polarizer and the top cover layer according to the exemplary embodiment of the present disclosure.

The top cover layer 90 is disposed such that it covers the patterned polarizer 80. The top cover layer 90 may cover not only the patterned polarizer 80 but also the fourth passivation layer 44 exposed between the straight lines of the patterned polarizer 80. The top cover layer 90 is disposed at the top of the backlight unit BLU so that various features disposed under the top cover layer 90 can be protected from the external environments (physical and/or chemical environments such as foreign matter, heat, moisture and oxygen).

The top cover layer 90 may include upper, lower and side faces 90a, 90b, 90s (90s1, 90s2, 90s3 and 90s4). In an exemplary embodiment, the side faces 90s (90s1, 90s2, 90s3 and 90s4) of the top cover layer may be aligned with (or in line with or overlap with) the side faces of the fourth passivation layer, respectively. It is, however, to be understood that the present disclosure is not limited thereto.

The top cover layer 90 may include an inorganic material. For example, the top cover layer 90 may be made of a material including at least one of silicon oxide, silicon nitride, silicon oxynitride and silicon nitride oxide. In some exemplary embodiments, the top cover layer 90 may include silicon nitride. The top cover layer 90 may be formed directly on the patterned polarizer 80 by depositing an inorganic material.

The thickness of the top cover layer 90 may be larger than the thicknesses of the passivation layers 41, 42 and 44 made of different inorganic materials disposed thereunder. For example, the thickness t₉₀ of the top cover layer 90 may range from 0.5 μm to 0.9 μm.

It is, however, to be understood that the present disclosure is not limited thereto. The top cover layer 90 may have substantially the same thickness as the first, second and fourth passivation layers 41, 42 and 44, and the top cover layer 90 may be made of a material different from the materials of the first, second and fourth passivation layers 41, 42 and 44. For example, the top cover layer 90 may include silicon nitride, and the first, second and fourth passivation layers 41, 42 and 44 may include silicon oxide. Then, the density of the top cover layer 90 may be greater than the density of the first, second and fourth passivation layers 41, 42 and 44.

The top cover layer 90 can prevent the patterned polarizer 80 from being physically and/or chemically damaged due to moisture permeation and/or external foreign matters. Besides, the top cover layer 90 can prevent the features disposed under the patterned polarizer 80, especially the wavelength conversion layer 30 from being physically and/or chemically damaged (as foreign matter is introduced from the outside, the display device is dented and/or pressed, and so on). For example, as the fourth passivation layer 44, the patterned polarizer 80 and the top cover layer 90 in addition to the second passivation layer 42 and the third passivation layer 43 are sequentially disposed above the wavelength conversion layer 30, the wavelength conversion layer 30 can be more effectively protected from physical and/or chemical damages.

As described above, since the patterned polarizer 80 replacing the lower polarizing film is remarkably thin, the overall thickness of the display device can be considerably reduced even if the top cover layer 90 is additionally disposed on the patterned polarizer 80, and thus the display device can become slimmer.

On the other hand, according to the exemplary embodiment of the present disclosure, the light guiding plate 10, the wavelength conversion layer and the reflective polarizing layer including the patterned polarizer 80 is integrally formed as one-piece, the process of attaching the lower polarizing film can be eliminated. As a result, the process of assembling the display device can become simpler. In addition, as the reflective polarizing layer is incorporated into the backlight unit BLU together with the wavelength converting layer 30, the distance by which the light emitted from the wavelength conversion layer 30 travels to the patterned polarizer 80 can be reduced. Specifically, as shown in FIG. 1, as the reflective polarizing layer is integrated with the wavelength conversion layer 30, the distance by which the light travels from the wavelength conversion layer 30 can be reduced. As a result, the amount of light leaked between the wavelength conversion layer 30 and the patterned polarizers 80 can be reduced, so that the total amount of light incident on the patterned polarizer 80 can be increased. Therefore, the amount of the polarized light passed through the patterned polarizer 80 can be increased. In addition, as the optical distance between the wavelength conversion layer 30 and the patterned polarizer 80 is reduced, the amount of leakage of the polarized light, which is not parallel to the transmission axis of the patterned polarizer 80 and is reflected and recycled, is reduced. As a result, it is possible to improve the recycling effects. As a result, the overall luminance of the display device can be increased.

Hereinafter, backlight units BLU according to other exemplary embodiments of the present disclosure and display devices including the backlight units BLU will be described. In the following description, the same or similar elements will be denoted by the same or similar reference numerals, and redundant descriptions will be omitted or briefly described.

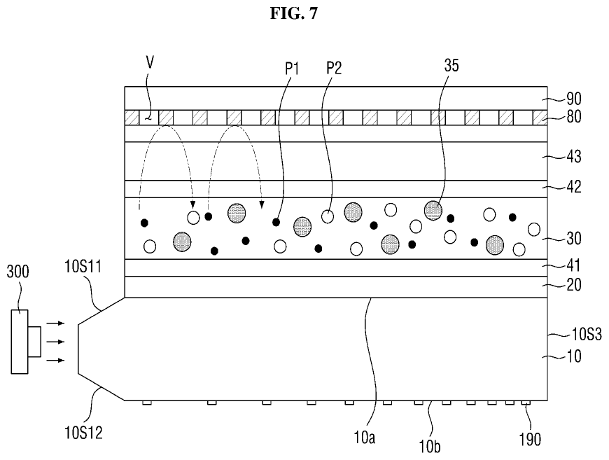

FIG. 7 is a cross-sectional view of a backlight unit according to another exemplary embodiment of the present disclosure.

The backlight unit according to the exemplary embodiment shown in FIG. 7 is different from the exemplary embodiment shown in FIGS. 1 to 6 in that the former includes a light guide plate having inclined edge faces.

According to the exemplary embodiment of the present disclosure, the light guide plate 10 may have a first edge face 10S11 extending outwardly from the upper side of the side face 10S1 in the thickness direction (e.g., the light incidence surface) and inclined downwardly in the thickness direction, and a second edge face 10S12 extending outwardly from the lower side of the side face 10S1 in the thickness direction and inclined upwardly in the thickness direction. The first edge face 10S11 and the second region face 10S12 may meet each other on the outer side of the light guide plate 10. Accordingly, the thickness of the light guide plate 10 increases toward the other side face 10S3 from the location where they meet each other that is opposed to it, and then the thickness is constant as the upper face 10a and the lower face 10b have a flat shape. The inclined edge faces 10S11 and 10S12 may be referred to as chamfered faces. The first edge face 10S11 and the second edge face 10S12 described above may be used to allow the light at the periphery of the light guide plate 10 (e.g., the side face 10s1) to efficiently exit out of the light guide plate 10 (e.g., toward the wavelength conversion layer 30).

Also in this exemplary embodiment of the present disclosure, the thickness and/or the density of the top cover layer 90 may be designed optimally for the protective function as compared with the other capping layers thereunder, so that it is possible to prevent foreign matters or the like from being introduced into the wavelength conversion layer 30 or the patterned polarizer 80 under the top cover layer 90. The top cover layer 90 may be damaged sometimes by external foreign matters or an external impact. Even so, the top cover layer 90 absorbs the impact or covers the damage, so that it is possible to prevent or suppress the underlying features (the wavelength conversion layer 30, the patterned polarizer 80, etc.) from being damaged physically and/or chemically.

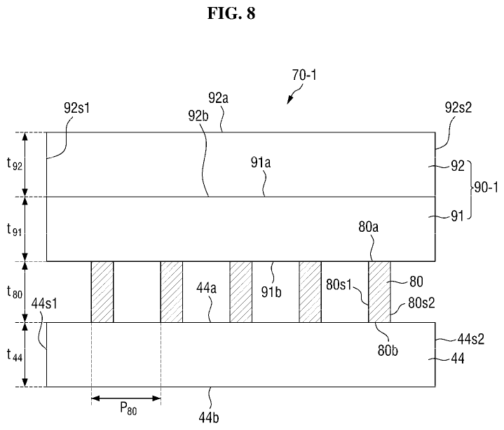

FIG. 8 is a cross-sectional view of a backlight unit including a polarizing member according to another exemplary embodiment of the present disclosure.

A polarizing member 70-1 according to the exemplary embodiment of the present disclosure shown in FIG. 8 is different from that according to the exemplary embodiment shown in FIGS. 1 to 6 in that the former further includes a second top cover layer 92 including an inorganic material different from that of the first top cover layer 90 and 91.

More specifically, the second top cover layer 92 may include upper, lower and side faces 92a, 92b, 92s; 92s1 and 92s2. In an exemplary embodiment, the side faces 92s; 92s1, 92s2, 92s3 and 92s4 of the second top cover layer may be aligned with (or in line with or overlap with) the side faces of the fourth passivation layer 44 and the side faces 91s of the first top cover layer, respectively. It is, however, to be understood that the present disclosure is not limited thereto. The side faces 92s of the second top cover layer may further extending outward than the side faces of the fourth passivation layer 44 and the side faces 91s of the first top cover layer. In addition, the side faces 92s of the second top cover layer may cover the side faces of the fourth passivation layer 44 and the side faces 91s of the first top cover layer side. It is, however, to be understood that the present disclosure is not limited thereto.

The thickness t₉₂ of the second top cover layer may range from 0.5 μm to 0.9 μm. That is to say, the thickness t₉₂ of the second top cover layer may be substantially equal to the thickness t₉₁ of the first top cover layer. In addition, the thickness t₉₁ of the first top cover layer, the thickness t₉₂ of the second top cover layer and the sum of the thicknesses of the first and second top cover layers (t₉₁+t₉₂) may be larger than the thickness of each of the underlying inorganic passivation layers (e.g., the first, second and fourth passivation layer 41, 42 and 44). In addition, the second top cover layer 92 may be made of an inorganic material having a density higher than that of the first top cover layer 91 (for example, silicon nitride). Accordingly, the top cover layer 90-1, in the first place, can effectively prevent the underlying features, especially the wavelength conversion layer 30 from being physically and/or chemically damaged (as foreign matter is introduced from the outside, the display device is dented and/or pressed, and so on).

Furthermore, the refractive index of the second top cover layer 92 may be greater than that of the first top cover layer 91. Specifically, as the refractive index of the material (e.g., silicon nitride) included in the second top cover layer 92 is greater than the refractive index of the material (e.g., silicon oxide) included in the first top cover layer 91, the reflection at the interface between the first top cover layer 91 and the second top cover layer 92 is reduced so that the transmittance to the display surface can be improved.

Also in this exemplary embodiment of the present disclosure, the thickness and/or the density of the top cover layer 90-1 may be designed optimally for the protective function as compared with the other capping layers thereunder, it is possible to prevent foreign matters or the like from being introduced into the wavelength conversion layer 30 or the patterned polarizer 80 under the top cover layer 90-1. The top cover layer 90-1 may be damaged sometimes by external foreign matters or an external impact. Even so, the top cover layer 90-1 absorbs the impact or covers the damage, so that it is possible to prevent or suppress the underlying features (the wavelength conversion layer 30, the patterned polarizer 80, etc.) from being damaged physically and/or chemically.

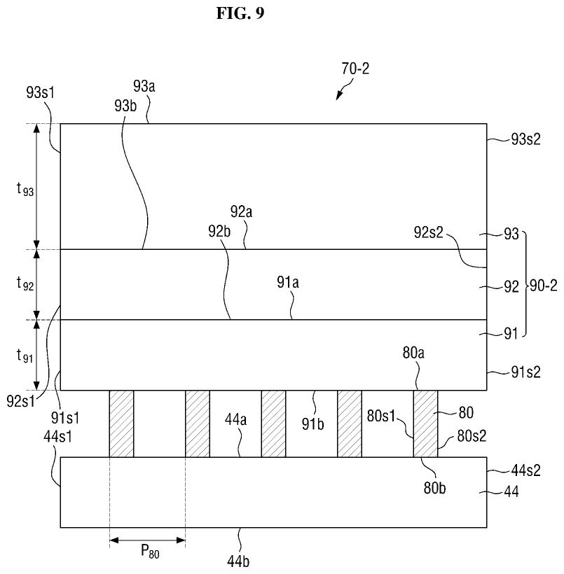

FIG. 9 is a cross-sectional view of a backlight unit BLU including a polarizing member according to yet another exemplary embodiment of the present disclosure.

A polarizing member 70-2 according to the exemplary embodiment shown in FIG. 9 is different from the exemplary embodiment shown in FIGS. 1 to 6 in that a top cover layer 90-2 further includes a third top cover layer 93 including an organic material different from a first top cover layer and a second top cover layer 91 and 92.

More specifically, the third top cover layer 93 may include upper, lower and side faces 93a, 93b, 93s; 93s1 and 93s2. In an exemplary embodiment, the side faces 93s; 93s1 and 93s2 of the third top cover layer may be aligned with (or in line with or overlap with) the side faces of the fourth passivation layer 44, the side faces 91s of the first top cover layer and the side faces 92s of the second top cover layer, respectively. It is, however, to be understood that the present disclosure is not limited thereto. The side faces 93s of the third top cover layer may further extending outward than the side faces of the fourth passivation layer 44, the side faces 91s of the first top cover layer and the side faces 92s of the second top cover layer. In addition, the side faces 93s of the third top cover layer may cover the side faces of the fourth passivation layer 44, the side faces 91s of the first top cover layer side and the side faces 92s of the second top cover layer. It is, however, to be understood that the present disclosure is not limited thereto.

The thickness t₉₃ of the third top cover layer may range from 3 μm to 7 μm. That is to say, the thickness t₉₃ of the third top cover layer may be thicker than the thickness (2 μm to 4 μm) of the third passivation layer 43 (or the first organic capping layer, the overcoat layer) disposed under the third top cover layer 93. For example, the thickness of the third top cover layer 43 (or the first organic capping layer, the overcoat layer) may be 3 μm, and the thickness t₉₃ of the third top cover layer may be 4 μm to 7 μm. The material of the third top cover layer 93 is not particularly limited as long as it can exhibit excellent planarization characteristics, light transmittance and impact buffering. For example, the third top cover layer 93 may be made of an epoxy resin, an acrylic resin, a cardo resin, an imide resin, a siloxane resin or a silsesquioxane resin.

The third top cover layer 93 can effectively block the permeation of a liquid such as a process liquid and prevent permeation of the external process liquid or the like from above the backlight unit BLU into the wavelength conversion layer 30. Furthermore, the third top cover layer 93 has a smaller density than the inorganic material and can mitigate external impact, and thus it can protect the inside from impact when the display device is pressed or foreign matter is introduced.

Also in this exemplary embodiment of the present disclosure, the thickness and/or the density of the top cover layer 90-2 may be designed optimally for the protective function as compared with the other capping layers thereunder, it is possible to prevent foreign matters or the like from being introduced into the wavelength conversion layer 30 or the patterned polarizer 80 under the top cover layer 90-2. The top cover layer 90-2 may be damaged sometimes by external foreign matters or an external impact. Even so, the top cover layer 90-2 absorbs the impact or covers the damage, so that it is possible to prevent or suppress the underlying features (the wavelength conversion layer 30, the patterned polarizer 80, etc.) from being damaged physically and/or chemically.

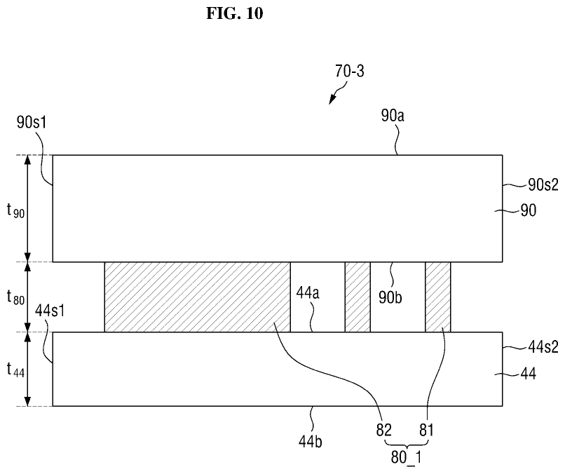

FIG. 10 is a cross-sectional view of a backlight unit including a polarizing member according to yet another exemplary embodiment of the present disclosure.

A polarizing member 70-3 according to the exemplary embodiment shown in FIG. 10 is different from that according to the exemplary embodiment shown in FIGS. 1 to 6 in that a surface pattern 82 working as a reflective plate is added to a patterned polarizer 81.

The surface pattern 82 of the polarizing member 70-3 may be formed in a non-opening region of a pixel PX of the display device 1000 to which a display panel 200 is added, which will be described below.

More specifically, the display panel 200 may include a plurality of pixels PX. Each of the plurality of pixels PX is driven by a thin-film transistor for driving the pixel PX and the like. The thin-film transistor may be electrically connected to the pixel PX and may be disposed adjacent to another pixel PX. Typically, the region where the thin-film transistor is disposed may be a region where light converted in the pixel PX is not emitted (or non-opening region). Therefore, the black matrix BM may be formed on the part of the display surface which overlaps the non-opening region in the thickness direction.

As mentioned earlier, the backlight unit BLU, especially the wavelength conversion layer 30 can be protected by the inorganic and/or organic capping layers disposed thereabove. However, it was not possible to prevent the underlying features (especially the wavelength conversion layer 30) from being damaged physically and/or chemically when foreign matter is introduced from the outside or the device is dented and/or pressed only with the existing inorganic and/or capping layers 42 and 43. In view of the above, according to the exemplary embodiment of the present disclosure, the backlight unit BLU may further include the top cover layer 90 capable of protecting the backlight unit BLU, especially the wavelength conversion layer 30 from the outside. As in the exemplary embodiment of the present disclosure, the thickness and/or the density of the top cover layer 90 is designed optimally for the protective function as compared with the other capping layers thereunder, such that the foreign matter or the like can be blocked by the top cover layer 90. The top cover layer 90 may be damaged by an external foreign matter or the like. In the backlight unit BLU according to the exemplary embodiment of the present disclosure, however, the top cover layer 90 is designed to cover such damage to protect the underlying features, and thus it is possible to prevent the wavelength conversion layer 30 from being physically and/or chemically damaged (as foreign matter is introduced from the outside, the display device is dented and/or pressed, and so on).

According to an exemplary embodiment of the present disclosure, the surface pattern 82 may be further formed in a region overlapping with the non-opening region of the polarizing member 70-3 in the thickness direction. The light exiting through the non-opening region is reflected back to the lower portion by the surface pattern 82, so that the luminous efficiency of the display device can be increased, and the power consumption of the display device can be reduced significantly.

Also in this exemplary embodiment of the present disclosure, the thickness and/or the density of the top cover layer 90 may be designed optimally for the protective function as compared with the other capping layers thereunder, so that it is possible to prevent foreign matters or the like from being introduced into the wavelength conversion layer 30 or the patterned polarizer 80 under the top cover layer 90. The top cover layer 90 may be damaged sometimes by external foreign matters or an external impact. Even so, the top cover layer 90 absorbs the impact or covers the damage, so that it is possible to prevent or suppress the underlying features (the wavelength conversion layer 30, the patterned polarizer 80, etc.) from being damaged physically and/or chemically.

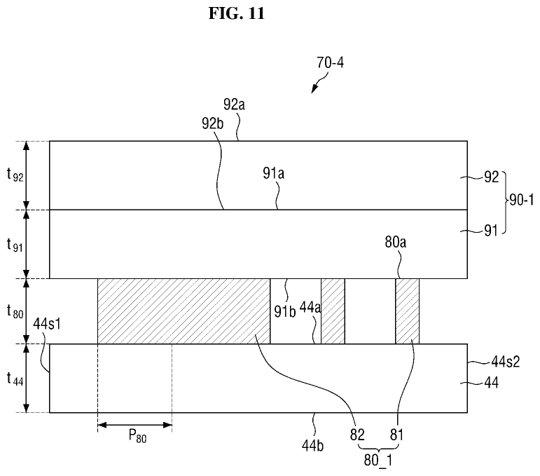

FIG. 11 is a cross-sectional view of a backlight unit including a polarizing member according to yet another exemplary embodiment of the present disclosure.

A polarizing member 70-4 according to the exemplary embodiment of the present disclosure shown in FIG. 11 is different from that according to the exemplary embodiment shown in FIGS. 1 to 6 in that the former further includes a second top cover layer 92 including an inorganic material different from that of the first top cover layer 91, and a patterned polarizer 80_1 of FIG. 11.

Also in this exemplary embodiment of the present disclosure, the thickness and/or the density of the top cover layer 90-1 may be designed optimally for the protective function as compared with the other capping layers thereunder, it is possible to prevent foreign matters or the like from being introduced into the wavelength conversion layer 30 or the patterned polarizer 80 under the top cover layer 90-1. The top cover layer 90-1 may be damaged sometimes by external foreign matters or an external impact. Even so, the top cover layer 90-1 absorbs the impact or covers the damage, so that it is possible to prevent or suppress the underlying features (the wavelength conversion layer 30, the patterned polarizer 80, etc.) from being damaged physically and/or chemically.

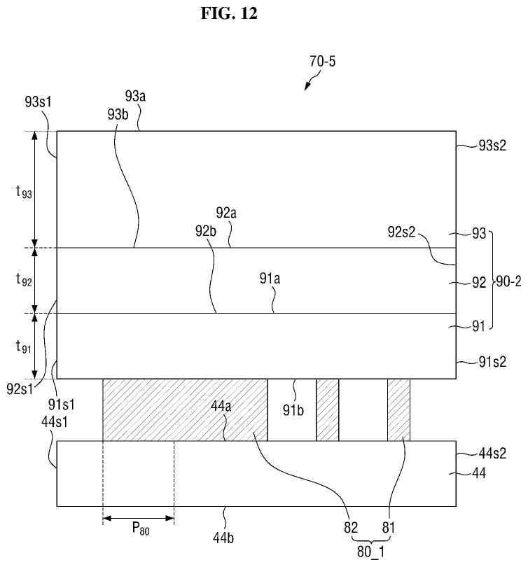

FIG. 12 is a cross-sectional view of a backlight unit BLU including a polarizing member according to yet another exemplary embodiment of the present disclosure.

A polarizing member 70-5 according to the exemplary embodiment of the present disclosure shown in FIG. 11 is different from that according to the exemplary embodiment shown in FIGS. 1 to 6 in that the former includes a third top cover layer 93 including an inorganic material different from that of the first top cover layer 91 and that of the second top cover layer 92, and a patterned polarizer 80_1 of FIG. 11.

Also in this exemplary embodiment of the present disclosure, the thickness and/or the density of the top cover layer 90-2 may be designed optimally for the protective function as compared with the other capping layers thereunder, it is possible to prevent foreign matters or the like from being introduced into the wavelength conversion layer 30 or the patterned polarizer 80 under the top cover layer 90-2. The top cover layer 90-2 may be damaged sometimes by external foreign matters or an external impact. Even so, the top cover layer 90-2 absorbs the impact or covers the damage, so that it is possible to prevent or suppress the underlying features (the wavelength conversion layer 30, the patterned polarizer 80, etc.) from being damaged physically and/or chemically.

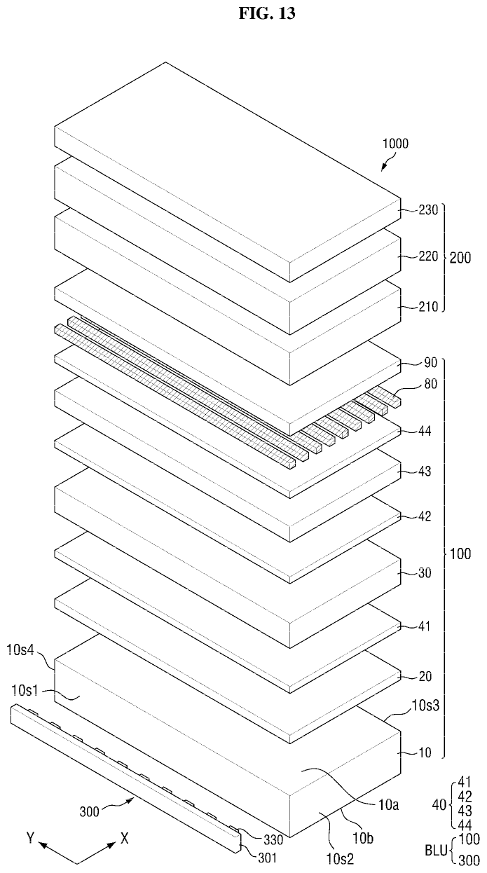

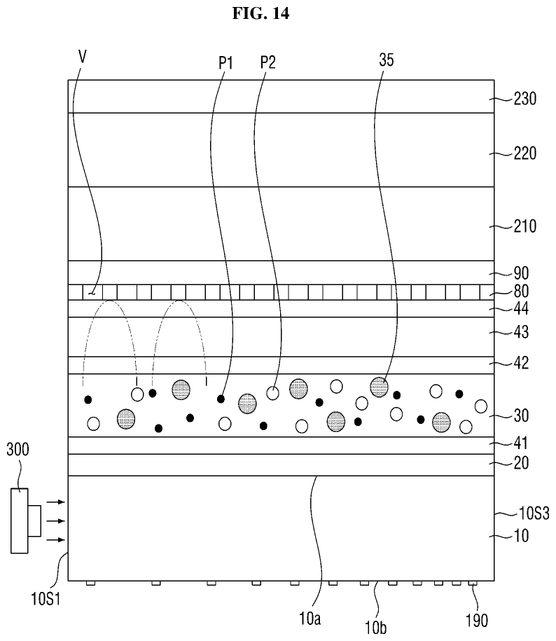

FIG. 13 is an exploded, perspective view of a display device according to an exemplary embodiment of the present disclosure and a modification (including the modification of the light guide plate of FIG. 3). FIG. 14 is a cross-sectional view of the display device according to the exemplary embodiment of the present disclosure and the modification.

Referring to FIGS. 13 and 14, the display device 1000 according to this exemplary embodiment may include any of the examples of the polarizing members 70, 70-1 to 70-2 in FIGS. 8 to 9. Specifically, the display device 1000 includes a light source 300, an optical member 100 disposed on an emission path of the light source 300, and a display panel 200 disposed above the optical member 100.

The display device 1000 may further include a reflective member (not shown) disposed below the optical member 100. The reflective member may include a reflective film or a reflective coating layer. The reflective member reflects the light exit through the lower face 10b of the light guide plate 10 of the optical member 100 back to the inside of the light guide plate 10.

The display panel 200 is disposed above the optical member 100. The display panel 200 receives light from the optical member 100 to display images. Examples of such light-receiving display panels that display images by receiving light may include a liquid-crystal display panel, an electrophoretic panel, etc. Although a liquid-crystal display panel will be described as an example in the following description, any of a variety of other light-receiving display panels can be employed.

The display panel 200 may include a first substrate 210, a second substrate 220 facing the first substrate 210, and a liquid-crystal layer (not shown) disposed between the first substrate 210 and the second substrate 220. The first substrate 210 and the second substrate 220 overlap with each other. In an exemplary embodiment, one of the substrates may be larger than the other substrate so that it may protrude further outward. Although not shown in the drawings, the second substrate 220 located above the first substrate 210 may be larger than the first substrate 210 and may protrude from the side where the light source 300 is disposed. The protruding part of the second substrate 220 may provide a space for mounting a driving chip or an external circuit board. Unlike the illustrated example, the first substrate 210 located below the second substrate 220 may be larger than the second substrate 220 and protrude outward. In the display panel 200, the first substrate 210 and the second substrate 220 overlap with each other, except for the protruding part, may be substantially aligned with the side face 10s of the light guide plate 10 of the optical member 100.

The display panel 200 may further include a polarizing plate 230 on the upper surface in the thickness direction of the first substrate 210. The polarizing plate 230 may include a polyvinyl alcohol-based polarizer and may be in the form of a film. The polarizing plate 230 may be disposed such that its polarization axis is orthogonal to that of the polarizing members 70 to 70-2 thereunder. The polarizing plate 230 can polarize the light emitted from the display panel 200 so that the image is perceived by a viewer's eyes.

Although not shown in the drawings, the display device 1000 may further include at least one optical film (not shown). One or more optical films (not shown) may be disposed between the optical member 100 and the display panel 200.

According to the exemplary embodiment of the present disclosure, the optical film (not shown) may include two layers of prism films are stacked on one another, and a film for improving brightness stacked on it (not shown). It is, however, to be understood that the present disclosure is not limited thereto. The display device 1000 may include optical films of the same kind or different kinds (not shown). For example, the stack structure may be formed by combining ones selected from a prism film, a diffusion film, a micro-lens film, a lenticular film, a polarizing film, a reflective polarizing film, a retardation film, a film for improving brightness, and the like.

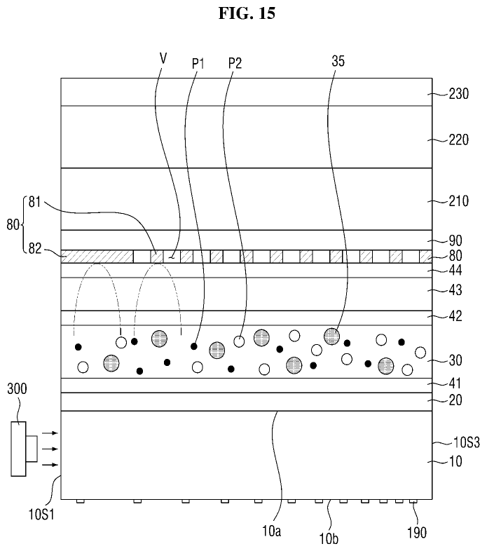

FIG. 15 is a cross-sectional view of a display device (including the modification of FIG. 3) including polarizing members 70-3, 70-4 and 70-5 according to yet another exemplary embodiment of the present disclosure.

As described above, the polarizing members 70-3, 70-4 and 70-5 according to the exemplary embodiments of the present disclosure may further include the surface pattern 82 in the region overlapping with the non-opening region of the polarizing members 70-3, 70-4 and 70-5 in the thickness direction. The light exiting through the non-opening region is reflected back to the lower portion by the surface pattern 82, so that the luminous efficiency of the display device can be increased, and the power consumption of the display device can be reduced significantly. Other effects described above with respect to the exemplary embodiments of the present disclosure and the modification will not be described to avoid redundancy.

Although the preferred embodiments of the present inventive concept have been disclosed for illustrative purposes, those skilled in the art will appreciate that various modifications, additions and substitutions are possible, without departing from the scope and spirit of the inventive concept as disclosed in the accompanying claims.

What is claimed is:

1. A backlight unit comprising:
a light guide plate;
a wavelength conversion layer disposed above the light guide plate; and
a reflective polarizing layer disposed above the wavelength conversion layer and comprising a patterned polarizer,
wherein the wavelength conversion layer and the reflective polarizing layer are integrally formed as one piece.

2. The backlight unit of claim 1, further comprising:
a low-refractive layer disposed between the light guide plate and the wavelength conversion layer; and
a passivation layer disposed between the wavelength conversion layer and the reflective polarizing layer,
wherein the light guide plate, the wavelength conversion layer and the reflective polarizing layer are integrally formed as one piece.

3. The backlight unit of claim 2, wherein the passivation layer comprises a first passivation layer disposed on the wavelength conversion layer, a second passivation layer disposed on the first passivation layer, and a third passivation layer disposed on the second passivation layer.

4. The backlight unit of claim 3, wherein the first passivation layer and the third passivation layer comprise an inorganic material, and wherein the second passivation layer comprises an organic material.

5. The backlight unit of claim 3, further comprising: a top cover layer disposed on the reflective polarizing layer.

6. The backlight unit of claim 5, wherein the top cover layer comprises an inorganic material, and wherein a thickness of the top cover layer is larger than a thickness of the first passivation layer and a thickness of the third passivation layer.

7. The backlight unit of claim 6, wherein the thickness of the top cover layer is 0.5 μm to 0.9 μm.

8. The backlight unit of claim 6, wherein the top cover layer comprises a first top cover layer comprising an inorganic material and a second top cover layer disposed on the first top cover layer and comprising an inorganic material different from that of the first top cover layer.

9. The backlight unit of claim 8, wherein the thickness of the top cover layer is larger than the thickness of the first passivation layer and the thickness of the third passivation layer.

10. The backlight unit of claim 8, wherein a density of the top cover layer is larger than a density of the first passivation layer and a density of the third passivation layer.

11. The backlight unit of claim 5, wherein the top cover layer comprises a first top cover layer and a second top cover layer disposed on the first cover layer, and wherein the first top cover layer comprises an inorganic material and the second top cover layer comprises an organic material.

12. The backlight unit of claim 11, further comprising: a third top cover layer between the first top cover layer and the second top cover layer, wherein a density of the third top cover layer is greater than a density of the first top cover layer.

13. A display device comprising:
a backlight assembly comprising
a light guide plate,
a wavelength conversion layer disposed above the light guide plate,
a reflective polarizing layer disposed above the wavelength conversion layer and comprising a patterned polarizer, and
a light source disposed on one side of the light guide plate; and
a liquid-crystal display panel disposed above the backlight assembly,
wherein the wavelength conversion layer and the reflective polarizing layer are integrally formed as one piece.

14. The display device of claim 13, further comprising: a low-refractive layer disposed between the light guide plate and the wavelength conversion layer; and a passivation layer disposed between the wavelength conversion layer and the reflective polarizing layer,
wherein the light guide plate, the wavelength conversion layer and the reflective polarizing layer are integrally formed as one piece.

15. The display device of claim 14, wherein the passivation layer comprises a first passivation layer disposed on the wavelength conversion layer, a second passivation layer disposed on the first passivation layer, and a third passivation layer disposed on the second passivation layer.

16. The display device of claim 15, wherein the first passivation layer and the third passivation layer comprise an inorganic material, and the second passivation layer comprises an organic material.

17. The display device of claim 15, further comprising: a top cover layer disposed on the reflective polarizing layer.

18. The display device of claim 17, wherein the top cover layer comprises an inorganic material, and wherein a thickness of the top cover layer is larger than a thickness of the first passivation layer and a thickness of the third passivation layer.

19. The display device of claim 17, wherein the top cover layer comprises a first top cover layer, a second top cover layer disposed on the first cover layer, wherein the first top cover layer comprises an inorganic material, and the second cover layer comprises an organic material.

20. The display device of claim 19, further comprising: a third top cover layer between the first top cover layer and the second top cover layer, wherein a density of the third top cover layer is greater than a density of the first top cover layer.
